(19) United States
(12) Patent Application Publication
(10) Pub. No.: US 2005/0055566 A1
(43) Pub. Date: Mar. 10, 2005

(54) COMPUTER SYSTEM AND METHOD FOR CONTROLLING THE SAME

(76) Inventors: Tsu-Ti Huang, Taipei Hsien (TW); Ping-Hung Chen, Taipei Hsien (TW); Cheng-Chan Yu, Taipei Hsien (TW); Yuan-Chun Chou, Taipei Hsien (TW); Yen-Hsing Chen, Taipei Hsien (TW)

Correspondence Address: (NAIPC) NORTH AMERICA INTERNATIONAL PATENT OFFICE, P.O. BOX 506, MERRIFIELD, VA, 22116, US

(21) Appl. No.: 10/710,927

(22) Filed: Aug. 13, 2004

(30) Foreign Application Priority Data
Sep. 10, 2003 (TW) 092125067

(51) Int. Cl. H04L 9/00

(52) U.S. Cl. 713/200

(57) ABSTRACT

A method controls a computing device with an security device wherein a first identification information is stored in said computing device and a second identification information is stored in said security device. The computing device has a BIOS program and an operation system program. The method includes the steps of executing said BIOS program of said computer system; fetching said first identification information and said second identification information; comparing said first identification information with said second identification information; and executing said operation system program if said second identification information matches said first identification information.

### BACKGROUND OF INVENTION

1. Field of the Invention

The present invention relates to a computer system, and more particularly, to a computer system controlled by a private key such as an integrated drive electronics device and related method.

2. Description of the Prior Art

In recent years, due to the explosive progress in information technology, personal computers are becoming one of the most important information devices in daily lives. In order to protect data stored in a personal computer from access by unknown users, a variety of data protection mechanisms for the personal computer are available in the market. These data protection mechanisms include, for example, a data encryption for directly encrypting data stored in a computer system and an authentication mechanism such as a BIOS or an OS authentication mechanism for preventing users like hackers from intruding. The data encryption encrypts original data stored in a computer system with a key of 128-bit long data and converts the original data into encrypted data of nonsensical form. Therefore, even the computer system is intruded and the encrypted data is “stolen”, in the end, the thief still cannot read the encrypted data without the key. The authentication mechanism protects the computer system by selectively executing an operating system according to input data such as a username and a password input to the computer system.

### SUMMARY OF INVENTION

It is therefore a primary objective of the invention to provide a computer system controlled by a private key, such as an integrated drive electronics device, and related method.

According to the invention, the method comprises (a) storing a first identification information into a first non-volatile memory of the computer system, (b) storing a second identification information into a second non-volatile memory of a first IDE device, (c) comparing the first identification information stored in the first non-volatile memory of the computer system and the second identification information stored in the second non-volatile memory of the first IDE device after the computer system is turned on, and (d) executing a predetermined program code if the first identification information matches the second identification information.

In a preferred embodiment, the first IDE device is a pocket drive and the predetermined program code is an operating system program code.

It is an advantage of the invention that the method does not execute the predetermined program code if the second identification information stored in the second non-volatile memory of the pocket drive is compared and matches the first identification information stored in the first non-volatile memory. In other words, if the second identification information stored in the second non-volatile memory of the pocket drive does not match the first identification information stored in the first non-volatile memory, the method will not execute the operating system program code so as to protect a computer system from access by an unknown user.

These and other objectives of the present invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a schematic diagram of a computer system of a preferred embodiment according to the present invention.

FIG. 2 is a function block diagram of the computer system shown in FIG. 1 according to the present invention.

FIG. 3 is a flowchart of a preferred method for controlling the computer system shown in FIG. 1 according to the present invention.

FIG. 4 is a flowchart of a second method for controlling the computer system shown in FIG. 1 according to the present invention.

FIG. 5 is a flowchart of a third method for controlling the computer system shown in FIG. 1 according to the present invention.

FIG. 6 is a flowchart of a fourth method for controlling the computer system shown in FIG. 1 according to the present invention.

FIG. 7 is a flowchart of a fifth method for controlling the computer system shown in FIG. 1 according to the present invention.

FIG. 8 is a flowchart of a sixth method for controlling the computer system shown in FIG. 1 according to the present invention.

### DETAILED DESCRIPTION

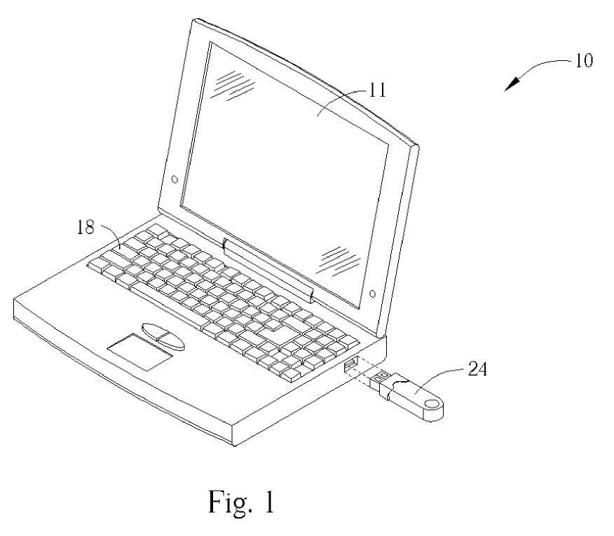

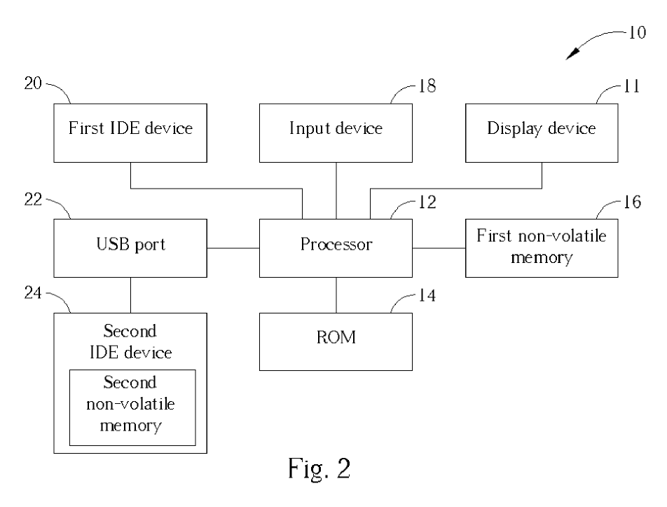

Please refer to FIG. 1 and FIG. 2. FIG. 1 is a schematic diagram of a computer system 10 of a preferred embodiment according to the present invention. FIG. 2 is a function block diagram of the computer system 10. The computer system 10 comprises a display device 11 for displaying information, a processor 12 electrically connected to the display device 11 for processing data and program codes, a read-only memory (ROM) 14 electrically connected to the processor 12 and having a basic input/output system (BIOS) program code stored therein, a first non-volatile memory 16 electrically connected to the processor 12 for storing at least a first identification information, an input device 18 electrically connected to the processor 12 for inputting an identification information, a first integrated drive electronics (IDE) device 20 electrically connected to the processor 12 for storing an operating system (OS) program code, a universal serial bus (USB) port 22, and a second IDE device 24 being capable of plugging into the USB port 22 and having a second non-volatile memory 26 for storing a second identification information.

In this preferred embodiment of the present invention, the BIOS program code controls the processor 12 to execute a power-on self test (POST) and detects whether or not the first IDE device 20 or other hardware components, such as a random access memory (RAM), functions normally. The first and second non-volatile memories 16 and 26 are flash memories, the input device 18 is a keyboard, the first IDE device 20 is a hard disk drive (HDD), and the second IDE device 24 is a pocket drive. Although the components of this embodiment are described using specific elements, it is noted that these specific elements are for illustrative purpose only but not for limiting the scope of the invention. For example, the input device 18 can be a mouse or a touch panel.

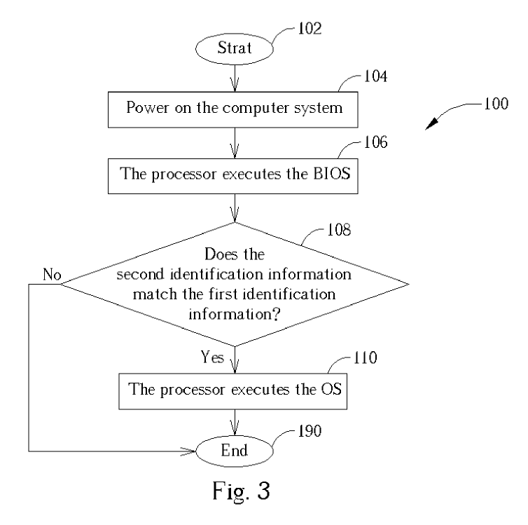

Please refer to FIG. 3, which is a flowchart of the method 100 for controlling the computer system 10 according to the present invention. The method 100 comprises the following steps:
step 102:start;
(The pocket drive 24 is assumed to be plugged into the USB port 22 of the computer system 10.);
step 104:power on the computer system 10;
step 106:the processor 12 executes the BIOS program code stored in the ROM 14;
(The processor 12 executes the BIOS program code stored in the ROM 14 automatically after the computer system 10 is powered on. In the preferred embodiment, the BIOS program code controls the processor 12 to compare the second identification information stored in the flash memory 26 of the pocket drive 24 with the first identification information stored in the flash memory 16.)
step 108:compare the second identification information with the first identification information. If the second identification information matches the first identification information, go to step 110, else go to step 190;
(It represents that the pocket drive 24 plugged into the USB port 22 of the computer system 10 is indeed the private key for the computer system 10 if the second identification information matches the first identification information. On the contrary, if the second identification information does not match the first identification information, either the pocket drive 24 plugged into the USB port 22 of the computer system 10 is not the private key for the computer system 10 or the USB port 22 of the computer system 10 does not have any IDE devices plugged into it.)
step 110:the processor 12 executes the OS program code; and

(After identifying that the pocket drive 24 is indeed the private key to turn on the computer system 10, the processor 12 executes the OS program code stored in the HDD 20. Strictly speaking, what the processor 12 executes first is a bootstrap loader stored in the HDD 20, and the OS program code is loaded by the bootstrap loader into a RAM for execution.)
step 190:end.

(The computer system 10 either has completed the POST or declines to execute the OS program code because the detection result of the pocket drive 24 plugged into the USB port 22 is not the private key for the computer system 10 or the USB port 22 does not have any IDE devices plugged into it.)

In this preferred embodiment of the present invention, the BIOS program code stored in the ROM 14 controls the processor 12 not to execute the OS program code after identifying that the second identification information does not match the first identification information (the pocket drive 24 is not the private key for the computer system 10 or the USB port 22 does not have any IDE devices plugged into it). The computer system 10 can further release an alarm signal at the same time to notify the user and/or manager of the computer system 10 that the private key does not match.

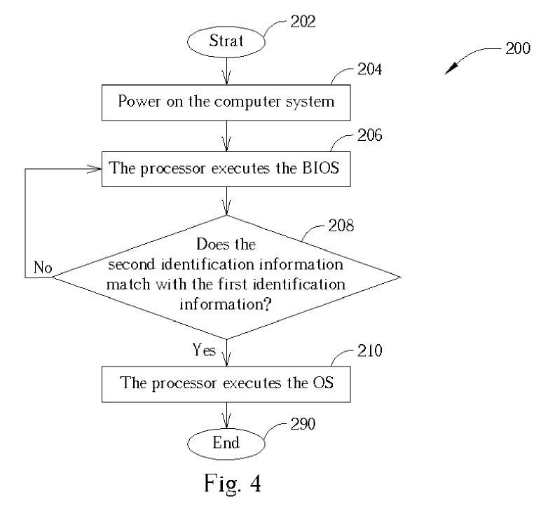

Please refer to FIG. 4, which illustrates a method 200 of a second embodiment according to the present invention. According to the method 200, the BIOS program code stored in the ROM 14 of the computer system 10 controls the processor 12 to compare the second identification information with the first identification information repeatedly, and prevents the processor 12 from executing the OS program code until the second identification information matches the first identification information. The method 200 comprises the following steps:
step 202:start;
(The pocket drive 24, another pocket drive, or nothing was plugged into USB port 22 of the computer system 10.)
step 204:power on the computer system 10;
step 206:the processor 12 executes the BIOS program code stored in the ROM 14;
(In the second embodiment, the BIOS program code controls the processor 12 to compare the second identification information stored in the flash memory 26 of the pocket drive 24 with the first identification information stored in the flash memory 16.)
step 208:compare the second identification information with the first identification information. If the second identification information matches the first identification information, go to step 210, else go to step 206;
(It means that the pocket drive 24 plugged into the USB port 22 of the computer system 10 is indeed the private key for the computer system 10 if the second identification information matches the first identification information. On the contrary, if the second identification information does not match the first identification information, either the pocket drive 24 plugged into the USB port 22 of the computer system 10 is not the private key for the computer system 10 or the USB port 22 of the computer system 10 does not have any IDE devices plugged into it. Then, the BIOS program code controls the processor 12 to compare the second identification information with the first identification information repeatedly until the second identification information matches the first identification information (the pocket drive 24 corresponding to the computer system 10 is plugged into the USB port 22 of the computer system 10.))
step 210:the processor 12 executes the OS program code;
and (After identifying that USB port 22 of the computer system 10 has the pocket drive 24 corresponding to the computer system 10 plugged into it, the processor 12 executes the OS program code stored in the HDD 20.)
step 290:end.

(The computer system 10 has executed the POST successfully.)

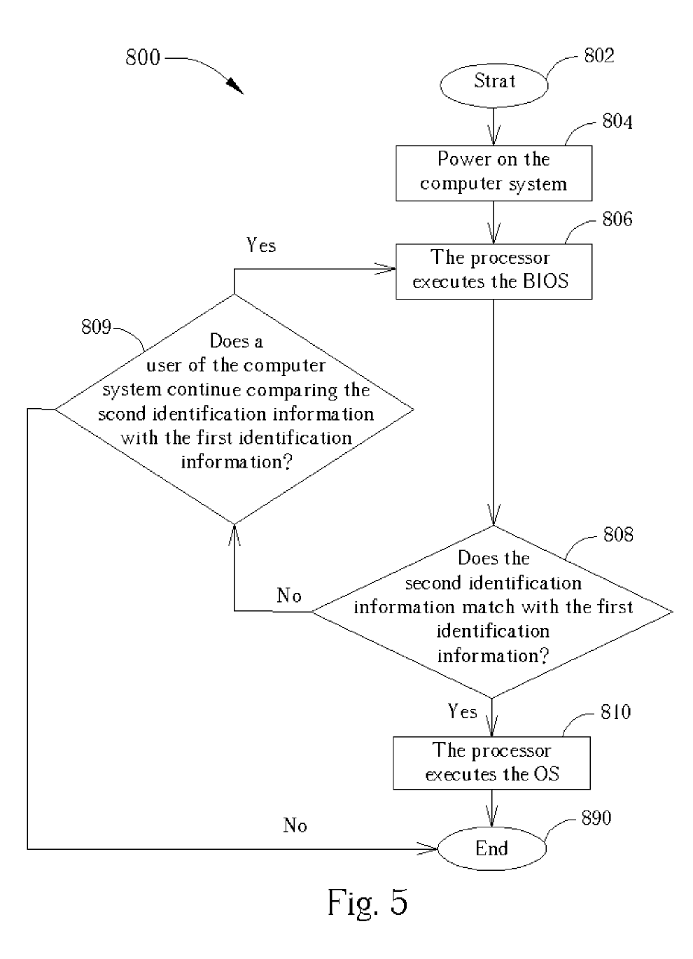

Please refer to FIG. 5, which illustrates a method 800 of a third embodiment according to the present invention. The method 800 is a combination of method 100 and method 200. for method 800, after determining whether or not the second identification information matches the first identification information, the BIOS program code can selectively control the processor 12 either to decline to execute the OS program code (as described in step 190 of the method 100) or to continuously execute the BIOS program code (as described in step 206 of the method 200). The method 800 comprises the following steps:
step 802:start;
(The pocket drive 24, another pocket drive, or nothing was plugged into USB port 22 of the computer system 10.)
step 804:power on the computer system 10;
step 806:the processor 12 executes the BIOS program code stored in the ROM 14;
(In the third embodiment, the BIOS program code controls the processor 12 to compare the second the identification information stored in the flash memory 26 of the pocket drive 24 with the first identification information stored in the flash memory 16.)
step 808:compare the second identification information with the first identification information. If the second identification information matches the first identification information, go to step 810, else go to step 809;
(it means that the pocket drive 24 plugged into the USB port 22 of the computer system 10 is indeed the private key for the computer system 10 if the second identification information matches the first identification information represents. On the contrary, if the second identification information does not match the first identification information, either the pocket drive 24 plugged into the USB port 22 of the computer system 10 is not the private key for the computer system 10 or the USB port 22 of the computer system 10 does not have any IDE devices plugged thereon.)
step 809:Querying whether repeating the step of comparing the second identification information with the first identification information or not? If yes, go to step 806, else go to step 890.

(If a user of the computer system 10 chooses to continue comparing the second identification information with the first identification information, the BIOS program code then controls the processor 12 to compare the second identification information with the first identification information again.)
step 810:the processor 12 executes the OS program code;
and (After identifying that the pocket drive 24 corresponding to the computer system 10 is plugged into the USB port 22 of the computer system 10, the processor 12 executes the OS program code stored in the HDD 20.)
step 890:end.

(The computer system 10 either has executed the POST successfully or declines to execute the OS program code because that the pocket drive 24 is not the private key for the computer system 10 or that no IDE devices is plugged into the USB port 22 of the computer system 10 and the user of the computer system 10 does not intend to compare the second identification information with the first identification information further.)

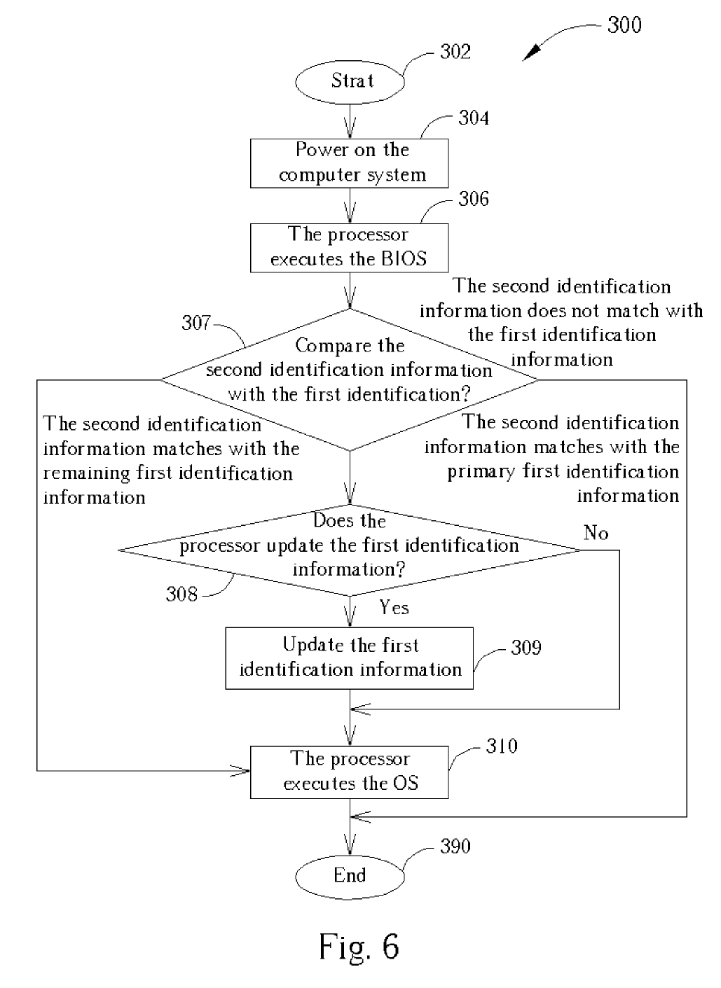

According to the method 100, 200 and 800, the BIOS program code only controls the processor 12 to compare the second identification information with the first identification information. Please refer to FIG. 6, which is a flowchart of method 300 of the fourth embodiment of the present invention. According to method 300, the flash memory 16 of the computer system 10 has a plurality of first identification information stored therein, and the BIOS program code stored in the ROM 14 of the computer system 10 controls the processor 12 to compare the second identification information with the plurality of first identification information and control the processor 12 to execute the OS program code if the second identification information matches one of the plurality of first identification information. The first identification information comprises primary first identification information and secondary first identification information, which correlate to different level of authority for the user. Accordingly, after identifying that the second identification information matches a primary identification information, the BIOS program code can also control the processor 12 to update the plurality of first identification information according to data inputted through the input device 18. In the computer system 10, although the flash memory 26 of the pocket drive 24 stores only one second identification information corresponding to the pocket drive 24, the flash memory 16 stores a plurality of first identification information, including one primary first identification information corresponding to this master pocket drive 24. In this embodiment, there is at least one secondary pocket drive can be used to turn on the computer system 10 without the authority of modifying first identification information. The computer system 10 will execute the OS program code when a pocket drive plugged into the USB port 22 of the computer system 10 is detected to be the secondary pocket drive. The method 300 comprises the following steps:
step 302:start;
(The master pocket drive 24, the secondary pocket drive, another irrelevant pocket drive, or nothing is plugged into the USB port 22 of the computer system 10, which both the master pocket drive 24 and the secondary pocket drive can be used to turn on the computer system 10.)
step 304:power on the computer system 10;
step 306:the processor 12 executes the BIOS program code stored in the ROM 14;
(According to the fourth embodiment, the BIOS program code controls the processor 12 to compare the second identification information stored in the flash memory 26 of the pocket drive 24 with each of the plurality of first identification information stored in the flash memory 16.)
step 307:compare the second identification information with the first identification information. If the second identification information matches the primary first identification information, go to step 308, if the second identification information matches one of the remaining first identification information other than the primary first identification information, go to step 310, else go to step 390;
(It means that the pocket drive 24 plugged into the USB port 22 of the computer system 10 corresponds to the master pocket drive for the computer system 10 if the second identification information matches the primary first identification information. The pocket drive plugged into the USB port 22 of the computer system 10 corresponds to the secondary pocket drive for the computer system 10 if the second identification information matches one of the remaining first identification information other than the primary first identification information. Lastly, if the second identification information does not match any of the plurality of first identification information, it represents that the pocket drive plugged into the USB port 22 of computer system 10 is neither the primary nor the secondary pocket drive for the computer system 10 or that the USB port 22 of the computer system 10 is not plugged, and the BIOS controls the processor 12 to turn off the computer system 10.)
step 308:Does the processor 12 update the plurality of first identification information? If yes, go to step 309, else go to step 310;
(The master pocket drive 24 is the only pocket drive having the authority to update the first identification information.)
step 309:The processor 12 updates the first identification information stored in the flash memory 16 according to data inputted via the input device 18 or the data stored in the pocket drive;
(The BIOS program code controls the processor 12 to display a dialog window on the display device 11 to request user of the computer system 10 to input data, such as username and password, and the processor 12 updates the first identification information according to the inputted data or the data stored in pocket drive.)
step 310:the processor 12 executes the OS program code; and (After identifying that the USB port 22 of the computer system 10 has a certain pocket drive, such as the master pocket drive 24 or the secondary pocket drive, corresponding to the computer system 10 plugged therein, the processor 12 executes the OS program code stored in the HDD 20.)
step 390:end.

(The computer system 10 has executed the POST successfully, or is turned off due to a detection result that a pocket drive plugged into the USB port 22 of the computer system 10 is neither the master pocket drive 24 nor the secondary pocket drive, or that the USB port 22 has in fact nothing plugged into it.)

According to the fourth embodiment, although both the master pocket drive 24 and the secondary pocket drive correspond to the plurality of first identification information and can be used to turn on the computer system 10, only the master pocket drive 24 corresponding to the primary first identification information has the authority to update the first identification information. In other words, a user of the master pocket drive 24 can update the first identification information and authorize a secondary pocket drive to turn on the computer system 10.

According to the method 300, the BIOS program code controls the processor 12 to execute the OS program code after determining whether or not to update the plurality of first identification information. However, the BIOS program can alternatively control the processor 12 to first execute the OS program code after determining that a pocket drive plugged into the USB port 22 of the computer system 10 is the primary or the secondary pocket drive corresponding to the computer system 10, and then determine whether or not to control the processor 12 to update the plurality of first identification information.

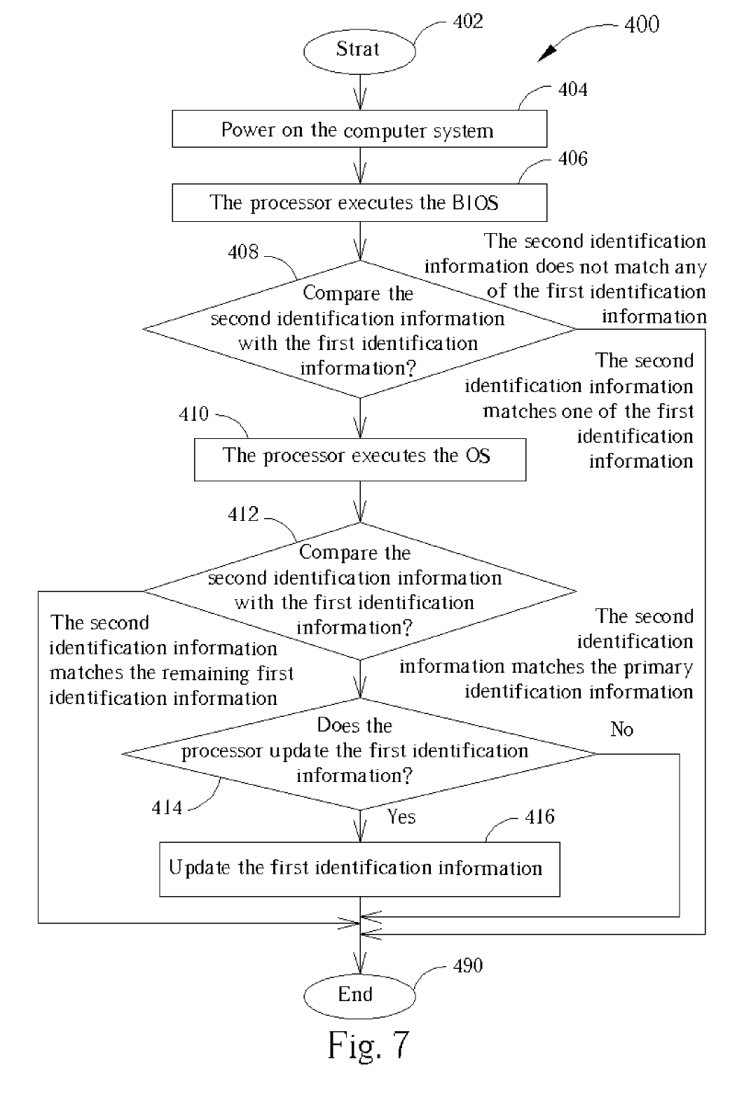

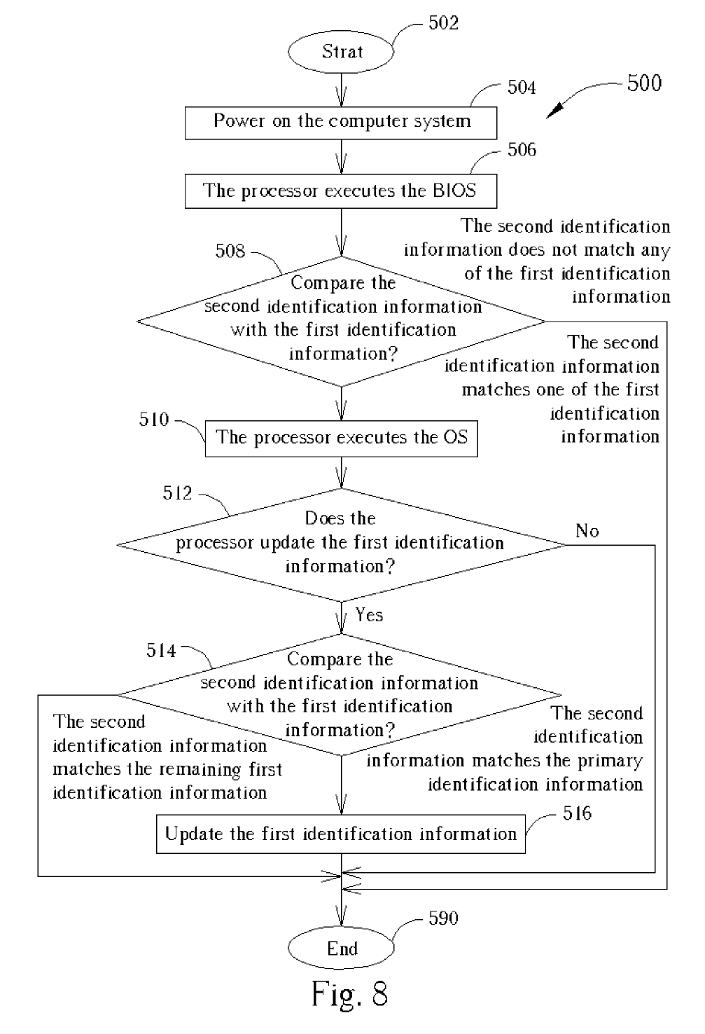

Please refer to FIG. 7 and FIG. 8, which are two flowcharts of a method 400 and a method 500 of the fifth and sixth embodiments respectively of the present invention. According to the methods 400 and 500, the BIOS program code controls the processor 12 to first execute the OS program code after determining whether or not a pocket drive plugged into the USB port 22 of the computer system 10 is the master or the secondary pocket drive, and then determine whether or not to control the processor 12 to update the plurality of first identification information. A difference between method 400 and method 500 is described as follows. For method 400, the BIOS program code first instructs the processor 12 to determine whether the second identification information matches the primary first identification information; if yes, then it queries whether to control the processor 12 to update the plurality of first identification information or not. For method 500, the BIOS program code first controls the processor 12 to query the user whether or not he/she wants to update the plurality of first identification information; if yes, then it controls the processor 12 to determine whether the second identification information matches the primary first identification information.

The method 400 comprises the following steps:
step 402:start;
(Either the master pocket drive 24, the secondary pocket drive, another pocket drive, or nothing is plugged in the USB port 22 of the computer system 10. Both the master pocket drive 24 and the secondary pocket drive can be used to turn on the computer system 10.)
step 404:power on the computer system 10;
step 406:the processor 12 executes the BIOS program code stored in the ROM 14;
(According to the fifth embodiment, the BIOS program code controls the processor 12 to compare the second identification information stored in the flash memory 26 of the pocket drive 24 with the plurality of first identification information stored in the flash memory 16.)
step 408:compare the second identification information with the first identification information. If the second identification information matches one of the plurality of first identification information, go to step 410, else go to step 490;
(It means that a pocket drive plugged into the USB port 22 of the computer system 10 is either the master pocket drive 24 or the secondary pocket drive if the second identification information matches one of the plurality of first identification information. On the contrary, if the second identification information does not match any of the plurality of first identification information, it represents that the pocket drive plugged into the USB port 22 of computer system 10 is neither the primary nor the secondary pocket drive for the computer system 10 or that the USB port 22 of the computer system 10 is not plugged, and the BIOS controls the processor 12 to turn off the computer system 10.)
step 410:the processor 12 executes the OS program code;
step 412:Compare the second identification information with the first identification information. If the second identification information matches the primary first identification information, go to step 414, else go to step 490;
(The pocket drive plugged into the USB port 22 of the computer system 10 is the master pocket drive 24, which is the pocket drive having the privilege to update the plurality of first identification information.)
step 414:Update the plurality of first identification information? If yes, go to step 416, else go to step 490;
step 416:The processor 12 updates the first identification information stored in the flash memory 16 according to data input by the input device 18 or the data stored in pocket drive;
(The BIOS program code controls the processor 12 to display a dialog window on the display device 11 to request a user of the computer system 10 to input data, such as username and a password, and the processor 12 updates the first identification information according to the inputted data or the data stored in the pocket drive.)
step 490:end.

(The computer system 10 has executed the POST successfully, or is turned off due to a detection result that a pocket drive plugged into the USB port 22 of the computer system 10 is neither the master pocket drive 24 nor the secondary pocket drive, or the USB port 22 has in fact nothing plugged into it.)

The method 500 comprises the following steps:
step 502:start;
(Either the master pocket drive 24, the secondary pocket drive, another pocket drive, or nothing is plugged in the USB port 22 of the computer system 10. Both of the master pocket drive 24 and the secondary pocket drive can be used to turn on the computer system 10.)
step 504:power on the computer system 10;
step 506:the processor 12 executes the BIOS program code stored in the ROM 14;
(According to the sixth embodiment, the BIOS program code controls the processor 12 to compare the second identification information stored in the flash memory 26 of the pocket drive 24 with the plurality of first identification information stored in the flash memory 16e.)
step 508:compare the second identification information with the first identification information. If the second identification information matches one of the plurality of first identification information, go to step 510, else go to step 590;
(The pocket drive plugged into the USB port 22 of the computer system 10 is either the master pocket drive 24 or the secondary pocket drive if the second identification information matches one of the plurality of first identification information. On the contrary, if the second identification information does not match any of the plurality of first identification information, it represents that the pocket drive plugged into the USB port 22 of computer system 10 is neither the primary nor the secondary pocket drive for the computer system 10 or that the USB port 22 of the computer system 10 is not plugged, and the BIOS controls the processor 12 to turn off the computer system 10.)
step 510:the processor 12 executes the OS program code;
step 512:Update the plurality of first identification information? If yes, go to step 514, else go to step 590;
step 514:Compare the second identification information with the plurality of first identification information. If the second identification information matches the primary first identification information, go to step 516, else go to step 590;
(The pocket drive plugged into the USB port 22 of the computer system 10 is the master pocket drive 24, which is the pocket drive having the privilege to update the plurality of first identification information.)
step 516:The processor 12 updates the first identification information stored in the flash memory 16 according to data inputted by the input device 18 or the data stored in pocket drive;
(The BIOS program code controls the processor 12 to display a dialog window on the display device 11 to request a user of the computer system 10 to input data, usually including username and password, and the processor 12 updates the first identification information according to the inputted data or the data stored in the pocket drive.)
step 590:end.

(The computer system 10 has executed the POST successfully, or is turned off due to a detection result that a pocket drive plugged into the USB port 22 of the computer system 10 is neither the master pocket drive 24 nor the secondary pocket drive, or the USB port 22 has in fact nothing plugged into it.)

According to the fourth, the fifth, and the sixth embodiments, the BIOS program code turns off the computer system 10 after detecting that the second identification information does not match the first identification information, as described in step 307 of the method 300, in step 408 of the method 400, and in step 508 of the method 500. However, the methods 300, 400, and 500 can also be designed to have the BIOS continue on comparing the second identification information with the first identification information if the second identification information does not match the first identification information, as described in step 809 of the method 800 shown in FIG. 5.

For methods 300, 400 and 500, updating the first identification information may also be carried out by inserting an unregistered pocket drive into a second USB port of the computer system 10 when the master pocket drive 24 is plugged in the USB port 22. The BIOS program code controls the processor 12 to update the first identification information according to the data stored in this unregistered pocket drive, thus completes the registration of this new pocket drive. After registration, the second identification information stored in this new pocket drive will match one of the updated plurality of first identification information stored in flash memory 16.

The pocket drive is not limited to one single type of memory drive; all devices that carry information can be utilized as the private key. In addition, it is not necessary for the identification information to be transmitted through USB port; even wireless route can be used to fetch the second identification information from the pocket drive.

Please be noted that steps 190, 290, 390, 490, 590 and 890 of the abovementioned embodiments represents ending of identification and/or updating process of methods 100, 200, 300, 400, 500 and 800. It does not identical to turning off the computer. If the second identification information does not match any of the plurality of first identification information, the BIOS program code, after finished either methods 100, 200, 300, 400, 500 or 800, will control the computer system 10. However, if the second identification information matches any of the plurality of first identification information, the OS program code will take charge of running the computer system 10.

In contrast to the prior art, the present invention controls a computer system with a firmware as a private key. Since only the user or the manufacturer of the computer system can own the private key, any one without the private key can neither turn on the computer system nor access the computer system, thus secures the privacy of data. Additionally, according to the embodiments of the present invention, the owner of the computer system can authorize a user of a pocket drive corresponding to a certain identification information (one of the plurality of first identification information) to turn on the computer system by updating the plurality of first identification information with the certain identification information, so as to broaden the usability of the computer system. Lastly, the first identification information can be alternatively stored in an individual memory like a ROM, while ordinary data different from the first identification information can be stored in a flash memory.

Those skilled in the art will readily observe that numerous modifications and alterations of the device and method may be made while retaining the teachings of the invention. Accordingly, the above disclosure should be construed as limited only by the metes and bounds of the appended claims.

1. A method for controlling a computing device with an security device wherein a first identification information is stored in said computing device and a second identification information is stored in said security device, said computing device further comprising a BIOS program and an operation system program, said method comprising the steps of:
executing said BIOS program of said computer system;
fetching said first identification information and said second identification information;
comparing said first identification information with said second identification information; and
executing said operation system program if said second identification information matches said first identification information.

2. The method of claim 1 in which said second identification information does not match said first identification information, further comprising the step of turning off said computing device.

3. The method of claim 1 in which said second identification information does not match said first identification information, further comprising the steps of:
querying whether to turn off said computing device or to fetch said second identification information again;
fetching said second identification information from said security device; and
comparing said second identification information with said first identification information.

4. The method of claim 1 in which said second identification information matches said first identification information, further comprising the steps of:
querying whether to update said first identification information; and
updating said first identification information.

5. The method of claim 4 in which said querying whether to update said first identification information step is performed before executing said operation system program.

6. The method of claim 5 in which said first identification information comprises primary first identification information and secondary first identification information, further comprising the steps of:
determining whether said second identification information matches said primary first identification information before querying whether to update said first identification information,
wherein said computing device queries whether to update said first identification information when said second identification information matches said primary first identification information, and said computing device executes said operation system program directly when said second identification information matches said secondary first identification information.

7. The method of claim 4 in which said querying whether to update said first identification information step is performed after executing said operation system program.

8. The method of claim 7 in which said first identification information comprises primary first identification information and secondary first identification information, further comprising the step of:
determining whether said second identification information matches said primary first identification information before querying whether to update said first identification information,
wherein said computing device queries whether to update said first identification information when said second identification information matches said primary first identification information, and said computing device skips said querying whether to update said first identification information step when said second identification information matches said secondary first identification information.

9. The method of claim 7 in which said first identification information comprises primary first identification information and secondary first identification information, further comprising the steps of:
determining whether said second identification information matches said primary first identification information after querying whether to update said first identification information,
wherein said computing device updates said first identification information when said second identification information matches said primary first identification information, and said computing forbids updating said first identification information when said second identification information matches said secondary first identification information.

10. A computing system comprising:
a security device having a second identification information stored therein; and
a computing device having a first identification information, a BIOS program and an operation system program stored therein, said computing device executing said BIOS program, fetching said second identification information from said security device, and comparing said first identification information with said second identification information; said computing device further executing said operation system program if said second identification information matches said first identification information.

11. The computing system of claim 10, wherein if said second identification information does not match said first identification information, said BIOS program controls said computing device to turn off.

12. The computing system of claim 10, wherein if said second identification information does not match said first identification information, said BIOS program further controls said computing device to query whether to turn off said computing device or to fetch said second identification information again; and wherein if said BIOS program is instructed to fetch said second identification information again, said computing device further fetches said second identification information from said security device and compares said second identification information with said first identification information.

13. The computing system of claim 10, wherein if said second identification information matches said first identification information, said computing device queries whether to update said first identification information or not, and said computing device updates said first identification information if said computing device is instructed to update said first identification information.

14. The computing system of claim 13, wherein said computing device queries whether to update said first identification information before executing said operation system program.

15. The computing system of claim 14 in which said first identification information comprises primary first identification information and secondary first identification information, wherein said computing device further determines whether said second identification information matches said primary first identification information before querying whether to update said first identification information; and wherein if said second identification information matches said primary first identification information, said computing device queries whether to update said first identification.

16. The computing system of claim 13, wherein said computing device queries whether to update said first identification information after executing said operation system program.

17. The computing system of claim 16 in which said first identification information comprises primary first identification information and secondary first identification information, wherein said computing device further determines whether said second identification information matches said primary first identification information before querying whether to update said first identification information; and wherein if said second identification information matches said primary first identification information, said computing device queries whether to update said first identification information; and wherein if said second identification information matches said secondary first identification information, said computing device skips said querying whether to update said first identification information step.

18. The computing system of claim 16 in which said first identification information comprises primary first identification information and secondary first identification information, wherein said computing device further determines whether said second identification information matches said primary first identification information after being instructed to update said first identification information; wherein if said second identification information matches said primary first identification information, said computing device updates said first identification information; and wherein if said second identification information matches said secondary first identification information, said computing device forbids updating said first identification information.

19. A computing system comprising:
an administrator security device having a primary second identification information stored therein;
a computing device having a plurality of first identification information, a BIOS program and an operation system program stored therein, wherein said plurality of first identification information comprises a primary first identification information and a secondary first identification information, said computing device executing said BIOS program, fetching said primary second identification information from said administrator security device, comparing said primary second identification information with said plurality of first identification information, and determining that said primary second identification information matches said primary first identification information, and querying whether to update said first identification information or not; and
a user security device having a secondary second identification information stored therein, wherein if said computing device is instructed to update said first identification information, said computing device fetches said secondary second identification information from said user security device and updates said first identification information to match said secondary second identification information.

20. The computing system of claim 19, wherein said computing device updates said primary first identification information to match said secondary second identification information.

21. The computing system of claim 19, wherein said computing device updates said secondary first identification information to match said secondary second identification information.

22. The computing system of claim 19, wherein updating said first identification information is executed by said BIOS program.

23. The computing system of claim 19, wherein updating said first identification information is executed by said operation system program.
